(19) United States
(12) Patent Application Publication
(10) Pub. No.: US 2010/0167851 A1
(43) Pub. Date: Jul. 1, 2010

(54) Hooded Valve and Valve Assembly for an Inflatable Object

(75) Inventor: Dann Burke, Reno, NV (US)

Correspondence Address: SILVERSKY GROUP LLC, 5422 LONGLEY LANE, SUITE B, RENO, NV, 89511, US

(73) Assignee: Tachikara U.S.A., Inc.

(21) Appl. No.: 12/346,627

(22) Filed: Dec. 30, 2008

(51) Int. Cl. F16K 15/20; A63B 41/00

(52) U.S. Cl. 473/610; 137/223; 473/611

(57) ABSTRACT

A hooded valve and valve assembly for use in inflatable objects, especially inflatable balls with an internal bladder that are inflated through insertion of an air needle, are disclosed. The valve includes an exterior chamber for easy insertion of the needle, a closed central portion for retention of air once the needle is removed, and a flexible interior chamber for enabling air to flow from the needle and to prevent the needle from puncturing the ball or the bladder.

### BRIEF DESCRIPTION OF THE INVENTION

The present invention is directed to a hooded valve and valve assembly for use in inflatable objects, especially inflatable balls with an internal bladder that are inflated through insertion of an air needle. The valve includes an exterior chamber for easy insertion of the needle, a closed central portion for retention of air once the needle is removed, and a flexible interior chamber for enabling air to flow from the needle and to prevent the needle from puncturing the ball or the bladder.

### CROSS-REFERENCES TO RELATED APPLICATIONS

Not Applicable.

### STATEMENT AS TO THE RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

### BACKGROUND OF THE INVENTION

Inflatable balls come in many different forms with a wide variety of valves, including valves that can be opened and blown into by a user and valves that can only be filled with a special needle designed to attach to a pump. This latter type of valve is commonly used in athletic balls, such as soccer, volleyballs, footballs, tetherballs, etc., where the balls are filled with air or other gases to create internal pressure. Non-controlled deflation through the valve opening would be highly undesirable. An example of one such valve is shown in Baltronis et al., U.S. Pat. No. 5,342,043, in which the valve for an American football is described as extending through a hole in one exterior panel and through the bladder for inflation and deflation purposes. Other versions of valves are shown in Ochoa, U.S. Pat. No. 3,107,683, and O'Hara et al., U.S. Pat. No. 5,403,003, as well as O'Neill et al., U.S. Publication Number 2006-0205547 A1.

As the most common type of valve assembly used in most bladder-based inflatable balls is not fully illustrated in any of the aforementioned references, an example of one such prior art valve assembly is depicted in FIG. 1A. As illustrated in the partial, cross-sectional diagram of FIG. 1A, the valve assembly is comprised of a central rubber valve 10, having an exterior open chamber 12, a solid interior portion 14, and a retainer ring 16. The valve 10 is inserted through a hole formed in an outer portion or panel of the ball 18 and through an interior bladder 20. Bladders are typically used in balls that have an outer portion or panel that is not capable of retaining air, such as a sewn leather or leather-like cover. The bladder is inserted within the outer cover and filled with air so as to inflate the ball and maintain a desirable PSI level.

Around the valve 10, the bladder has a thicker area 22 to provide more rigidity for the valve 10, and a bulbous (i.e.: valve housing) area 24, which is glued to the thicker area 22 and that holds the valve 10 in place against the thicker area 22. The combination of the valve 10 and the valve housing 24 form what is referred to herein as the “valve assembly” in bladderless balls, while in bladder-based balls, the valve housing further includes the bladder itself, usually in the form of the thicker area 22. When a needle is inserted through the exterior open chamber 12, it is directed toward the solid interior portion 14, where it pierces the rubber along a line 26 and exits into the interior area of the ball. The needle 30 is shown in FIG. 1B inserted within the valve 10 and into the interior portion of the ball. When the air opening 32 near the tip of the needle 30 reaches the interior area of the ball, air can be pumped into the ball to inflate the ball. When the needle 30 is removed from the valve 10, the opening along the line 26 created in the solid interior portion 14 closes and seals the air inside the bladder. As illustrated in the partial, cross-section of FIG. 1B, the needle 30 extends a significant distance into the interior portion of the bladder, which can be problematic.

To reduce shipping container space when balls are shipped from the manufacturer to a distributor, to save on storage space at various distributors, and to save space on receiving docks, balls are commonly shipped deflated. This is particularly true when balls are sent to institutions, such as schools and volleyball clubs. It is preferable to leave the balls completely or partially deflated (referred to herein as a “deflated ball”), until they are ready to be used by the consumer, at which point they are inflated. A deflated ball is typically folded, which causes the internal bladder wall 20 to fold over and in front of the valve assembly. When a consumer inserts a needle 30 into the valve 10 of a deflated ball, it is not uncommon to have the needle 30 extend beyond the end of the valve assembly and pierce a portion of the bladder 20 that gets in the way of the needle 30. FIG. 1B illustrates the needle 30 piercing a portion of the bladder 20 of a deflated ball. Since the outer covering of the ball cannot retain air, when the bladder is punctured, the ball is ruined. A large percentage of all deflated balls returned to distributors or manufacturers are due to bladders punctured by a needle.

In addition to being filled with air/gas, the bladder of some balls, primarily soccer balls, are also filled with a fine filament material to give the ball a different feel and density. When a needle is inserted into a ball with these filaments, it is not uncommon for a number of the filaments to get pulled into the opening along the line 26 created in the solid interior portion 14, which allows air to leak out of the valve. To prevent this from occurring, as illustrated in prior art FIG. 2, some balls include a foam filter material 34 that extends from the thicker area 22 to past the tip of the needle 30. Since the foam filter material 34 is only meant to prevent the filament material from being pulled into the valve 10, it does nothing to prevent the needle from puncturing a hole in the bladder 20 if the person filling the ball pushes hard enough on the needle. In such a case, the needle will push all the way through the foam and puncture the bladder 20 anyway.

### BRIEF DESCRIPTION OF THE SEVERAL VIEWS OF THE DRAWING

PRIOR ART FIGS. 1A and 1B are partial, cross-sectional views of a prior art valve assembly for a bladder-based ball without and with a needle inserted, respectively;

PRIOR ART FIG. 2 is a partial, cross-sectional view of a prior art valve assembly for a filament filled bladder-based ball;

FIG. 3 is a partial, cross-sectional view of a hooded valve assembly in accordance with the present invention;

FIG. 4 is a partial, cross-sectional view of the hooded valve assembly of FIG. 3 with a needle inserted in the hooded valve; and

FIG. 5 is a side view of the hooded valve of FIG. 3 illustrating deformation of the hooded portion of the valve when pressure is applied against the needle.

### DETAILED DESCRIPTION OF THE INVENTION

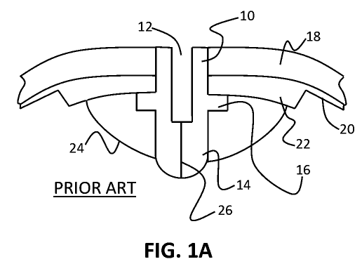

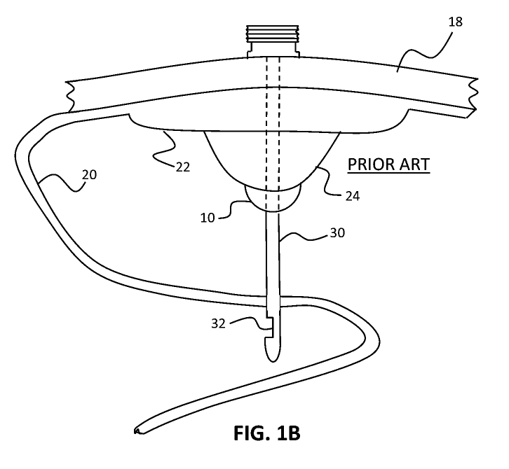

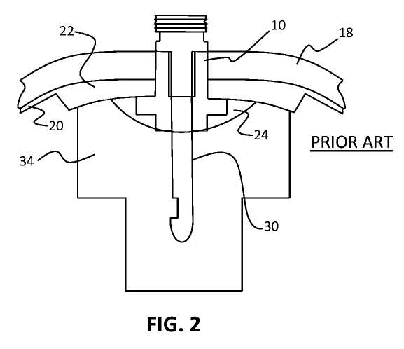

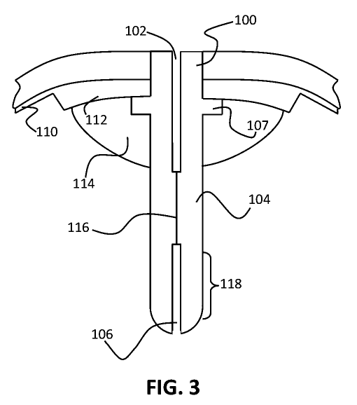

The present invention is directed to a hooded valve and valve assembly for use in inflatable objects, especially inflatable balls with an internal bladder that are inflated through insertion of an air needle. The present invention could be used in any type of inflatable object that has an air retainer, i.e., the ability to retain air, which might be the walls of the ball itself, or some type of inserted object, such as an air bladder. As depicted in FIG. 3, the valve assembly includes central rubber (or similar material) value 100, having an exterior chamber 102 for easy insertion of the needle, a closed central portion 104 for retention of air once the needle is removed, and a flexible interior chamber 106 for enabling air to flow from the needle and to prevent the needle from puncturing the ball or the bladder. A retainer ring 107 serves to keep the valve 100 from being pulled out of the ball by friction forces created by the needle as it is removed or from being knocked out of the ball during play.

The valve 100 is inserted through a hole formed in an outer portion or panel 108 of the ball and through a hole in an interior bladder 110, typically made of butyl. The retainer ring 107 holds the valve 100 in place against the thicker area 112 of the bladder 110 until the valve housing 114 is glued to the thicker area 112 so as to affix the valve 100 in place. When a needle is inserted through the exterior chamber 102, it is directed toward the closed central portion 104, where it pierces the rubber along a line 116.

The closed central portion 104 of the valve 100 may be pre-pierced with a sharp, narrow diameter instrument when the valve 100 is manufactured to make sure that the needle will travel along the line 116 and not exit through the side of the central portion 104 and defeat the purpose of the hooded area 118. Upon exiting the central portion 104, the needle will enter the flexible interior chamber 106 rather than the interior portion of the ball. Prior art valves are approximately 10 mm in length. The valve 100 of the present invention would be almost three times as long so as to assure that the air needle will not be able to extend beyond the interior end of the valve 100. The added length of the valve 100, when made of the same rubber material as prior art valves, only adds about 0.4 grams (0.02 ounces) of weight and should not introduce wobble or unbalancing of the ball or affect playability.

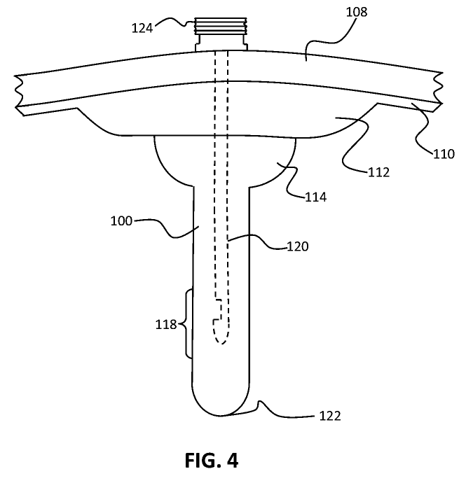

FIG. 4 illustrates the needle 120 (as a dashed line) when it has been fully inserted into the valve 100. As shown, the tip of the needle 120 does not extend to the end of the valve 122, but rather is positioned about midway into the hooded area 118. Due to the space created by the flexible interior chamber 106, air exiting the needle 120 as air is pumped into the ball (the pump is not illustrated, but would be connected to the upper threaded portion 124 of the needle) will be able to exit the interior chamber 106 and help to inflate the bladder 110. When the ball is inflated to the user's satisfaction, the needle 120 would be removed and the central portion 104 would close behind the needle, thereby preventing air from escaping the ball through the valve 100.

In addition to having the bladder protection benefits noted below, the addition of the hooded area 118 also eliminates the need to glue a foam filter around the interior portion of the valve 100. The small opening formed by the interior chamber 106 to the interior of the ball would also prevent filaments from being able to enter the interior chamber and the needle 120 from being able to pull those filaments into the central portion 104 when the needle 120 was withdrawn by a user. Hence, the single valve of the present invention could be used on all bladder based balls as well as filament filled balls in place of current prior art solutions.

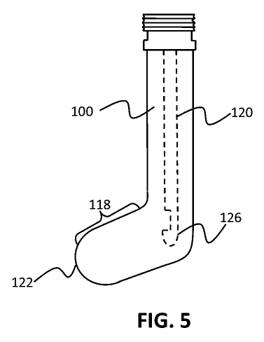

As illustrated in FIG. 5, when a user inserts the needle 120 into the valve 100, no matter how roughly and carelessly they may do so, the needle is protected by the hooded area 118. If the force applied by the user is parallel to the length of the valve 100 and needle 120, the length and relatively thick sides of the interior chamber 106 limit compression of the rubber material of the valve 100 and thereby prevent the needle from being pushed through the opening at the end 122 of the valve 100. If the force applied by the user is at some other angle to the valve, the length of and the hollow interior of the interior chamber 106 enables the hooded area 118 to bend in response, while the thick sides of the interior chamber 106 protect the tip 126 of the needle 120 from protruding through the sides of the interior chamber 106. Thus, when a user holds the portion of the ball directly across from the valve 100, thereby pushing the partially inflated bladder against the end 122 of the valve 100, and inserts the needle 120 into the valve 100 to inflate the ball, the needle 120 will not be able to puncture the bladder 110 because the hooded area 118 will either compress or bend to protect the end 122 of the needle 120. The cost of elongating the valve 100 and creating the hooded area 118 is relatively minor in comparison to the cost of prior art valves. The benefit of creating the hooded area is important because it will reduce a significant portion of the balls returned to distributors and manufacturers for alleged defects, which were really caused by improper inflation that resulted in air needle inflicted puncture holes.

Various alternatives to the present invention include forming the valve of a combination of materials, versus the same materials as the rest of the valve, or creating a different shape for the hooded area, such as a bulbous end to the valve. For example the hooded area could be formed of a harder more rigid material than the flexible rubber portion of the valve. This has the advantage of decreasing the likelihood that the needle tip could puncture through the sides of the hooded area, but it has disadvantages as well. Mixing two materials, the rubber of the valve with the harder material of the hooded area will require additional labor and material costs and introduces a potential point of failure should the hardened portion break away from the rubber portion. Further, if a user pushed hard enough against the combination of the needle and the valve assembly during an attempted inflation attempt, the needle may be bent, thereby making it impossible to withdraw from the ball or requiring the needle to be replaced.

Likewise, creating a different shape to the hooded area has both advantages and disadvantages. While a bulbous hooded area would insure that it would be impossible to puncture the sides of the valve, due to the thick sides created by the bulbous hooded area, needle bending would still be a problem and the bulbous hooded area would add extra weight to the balls, which would unbalance the balls and impact playability. Hence, the narrow interior chamber of the present invention and illustrated in the various figures herein is the preferred embodiment.

While the present invention has been illustrated and described in terms of a preferred embodiment and several alternatives herein in association with the various drawing figures, it should not be limited to just the particular description contained in this specification. Additional alternative or equivalent components and steps could be used to practice the present invention.

What is claimed is:

1. An inflatable object, comprising:
an air retainer for holding air pumped into the inflatable object with an air needle;
a valve including an exterior portion inserted through the air retainer for receiving the air needle, a central portion for sealing air released by the air needle inside the air retainer, and an interior portion for surrounding the air needle when the air needle is fully inserted into the air retainer; and
a valve housing for holding the valve in a fixed position relative to the air retainer.

2. The inflatable object of claim 1, wherein the interior portion includes a circular wall forming an interior chamber for receiving an end of the air needle and allowing air exiting the air needle to enter the air retainer.

3. The inflatable object of claim 2, wherein the circular wall is formed of a flexible material that compresses and/or bends when a force applied against the inflatable object pushes a portion of the air retainer against the valve and that prevents the end of the air needle from exiting the interior chamber.

4. The inflatable object of claim 3, wherein the circular wall has a thickness that prevents the end of the air needle from puncturing the circular wall when the force is applied.

5. The inflatable object of claim 1, wherein the air retainer is a bladder having a thickened area to which the valve housing is affixed.

6. The inflatable object of claim 1, wherein the valve further includes a retainer ring that is held against the air retainer by the valve housing and that retains the valve within the inflatable object.

7. A valve assembly of an inflatable object, comprising:
a valve including an exterior portion inserted through the inflatable object for receiving an air needle, a central portion for sealing air released by the air needle inside the inflatable object, and an interior portion for surrounding the air needle when the air needle is fully inserted into the inflatable object; and
a valve housing for holding the valve in a fixed position relative to the inflatable object.

8. The valve assembly of claim 7, wherein the interior portion includes a circular wall forming an interior chamber for receiving an end of the air needle and allowing air exiting the air needle to enter the inflatable object.

9. The valve assembly of claim 8, wherein the circular wall is formed of a flexible material that compresses and/or bends when a force applied against the inflatable object pushes a portion of the inflatable object against the valve and that prevents the end of the air needle from exiting the interior chamber.

10. The valve assembly of claim 9, wherein the circular wall has a thickness that prevents the end of the air needle from puncturing the circular wall when the force is applied.

11. The valve assembly of claim 8, wherein the circular wall has a length and a thickness that prevents the end of the air needle from exiting the interior chamber when a force applied against the inflatable object pushes a portion of the inflatable object against the valve.

12. The valve assembly of claim 7, wherein the valve further includes a retainer ring that is held against an interior of the inflatable object by the valve housing and that retains the valve within the inflatable object.

13. A valve of an inflatable object, comprising:
an exterior portion that forms a passage way for an air needle between an exterior of the inflatable object and an interior of the inflatable object;
a central portion for sealing air released by the air needle inside the inflatable object; and
an interior portion for surrounding the air needle when the air needle is fully inserted into the inflatable object.

14. The valve of claim 13, wherein the interior portion includes a circular wall forming an interior chamber for receiving an end of the air needle and allowing air exiting the needle to enter the inflatable object.

15. The valve of claim 14, wherein the circular wall is formed of a flexible material that compresses and/or bends when a force applied against the inflatable object pushes a portion of the inflatable object against the valve and that prevents the end of the air needle from exiting the interior chamber.

16. The valve of claim 15, wherein the circular wall has a thickness that prevents the end of the air needle from puncturing the circular wall when the force is applied.

17. The valve of claim 14, wherein the circular wall has a length and a thickness that prevents the end of the air needle from exiting the interior chamber when a force applied against the inflatable object pushes a portion of the inflatable object against the valve.

18. The valve of claim 13, wherein the valve further includes a retainer ring that is held against the interior of the inflatable object by a valve housing and that retains the valve within the inflatable object.

19. The valve of claim 13, wherein the valve is formed of a flexible material, and wherein the interior portion includes a circular wall forming an interior chamber that compresses and/or bends when a force applied against the inflatable object pushes a portion of the inflatable object against the valve and that prevents the end of the air needle from exiting the interior chamber.

20. The valve of claim 13, wherein the central portion is formed of a solid flexible material that allows the air needle to pass from the exterior portion to the interior portion to deliver air inside the inflatable object and that seals the air into the inflatable object when the air needle is removed from the central portion.
